(19) United States
(12) Patent Application Publication
(10) Pub. No.: US 2005/0243060 A1
(43) Pub. Date: Nov. 3, 2005

(54) Information input apparatus and information input method of the information input apparatus

(75) Inventors: Atsuo Shono, Tachikawa-shi (JP); Yasushi Tomizawa, Fuchu-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/108,764

(22) Filed: Apr. 19, 2005

(30) Foreign Application Priority Data
Apr. 28, 2004 (JP) 2004-134498

(51) Int. Cl. G09G 5/08

(52) U.S. Cl. 345/158

(57) ABSTRACT

A two-dimensional position detection unit takes the procedure so that two ultrasonic speakers attached to both end portions of a wrist outputs an ultrasonic wave while five ultrasonic microphones attached to fingertips detect it. The two-dimensional position detection unit measures time difference from output to detection of the ultrasonic wave. Then, the two-dimensional position detection unit calculates a two-dimensional position of each fingertip attached with the ultrasonic microphones based on the time difference. Further, an action detecting unit detects an occurrence of a predetermined change in acceleration outputted by the acceleration sensors attached to each fingertip and having sensitivity in the direction vertical to a palm of a hand (x-y plane). Then, the action detecting unit recognizes an action of hitting a keyboard.

### CROSS-REFERENCE TO RELATED APPLICATIONS

This application is based upon and claims the benefit of priority from prior Japanese Patent Application No. 2004-134498, filed Apr. 28, 2004, the entire contents of which are incorporated herein by reference.

### BACKGROUND OF THE INVENTION

1. Field of the Invention

The present invention relates to an information input apparatus, which enables key input to an information processing apparatus without key touch, and to an information input method of the information input apparatus.

2. Description of the Related Art

In recent years, battery-drivable and portable information processing apparatuses such as notebook type personal computers and PDAs (Personal Digital Assistant) have come into wide use. This kind of information processing apparatus is usable anywhere. Therefore, this serves to greatly improve work efficiency of salespersons, for example.

If this kind of information processing apparatus is used in a train during business transfer, a keyboard is not necessarily usable, unlike indoors. For this reason, information input apparatuses for enabling various inputs in place of the keyboard have been recently researched and developed. An information input apparatus enabling input using hand action exists as one of the forgoing apparatuses (for example, see JPN. PAT. APPLN. KOKAI Publication No. 6-59805).

The information input apparatus disclosed in the foregoing Publication No. 6-59805 detects only two-dimensional coordinates of each finger. For example, considering a keyboard operation, it is determined on which key each finger is placed; however, it is not determined whether or not each finger makes an action depressing a key. In other words, the foregoing apparatus is not suitable to an information input apparatus for the information processing apparatus. The same problem as above arises in handling electronic appliances having several operation buttons without being limited to the keyboard operation of the information input apparatus.

### BRIEF SUMMARY OF THE INVENTION

According to an embodiment of the present invention, an information input apparatus comprises: first and second signal sending units attached to right and left end portions of a wrist with a distance therebetween; at least one signal receiving unit, attached to a tip portion of each finger of a hand, configured to receive a signal outputted from the first or second signal sending unit; an acceleration sensors attached to at least one fingertips of fingers attached with the signal receiving unit; a fingertip position detecting unit configured to detect a relative position of a tip portion of each finger attached with the signal receiving unit in a two-dimensional space with its origin at the attached position of either the first or second signal sending unit based on an elapsed time period from a time when the first signal sending unit outputs a signal to a time when each signal receiving unit receives the signal, and an elapsed time period from a time when the second signal sending unit outputs a signal to a time when each signal receiving unit receives the signal; and an action detecting unit configured to detect an action of each finger attached with the acceleration sensor based on acceleration information outputted from each of the acceleration sensors.

According to an another embodiment of the present invention, an information input apparatus comprises: at least one signal sending unit attached to a tip portion of each finger of a hand; first and second signal receiving units, attached to right and left end portions of a wrist with a distance therebetween, configured to receive a signal outputted from the signal sending unit; an acceleration sensors attached to at least one fingertips of fingers attached with the signal sending unit; a fingertip position detecting unit configured to detect a relative position of a tip portion of each finger attached with the signal sending unit in a two-dimensional space with its origin at the attached position of either the first or second signal receiving unit based on an elapsed time period from a time when each signal sending unit outputs a signal to a time when the first signal receiving unit receives the signal, and an elapsed time period from a time when each signal sending unit outputs a signal to a time when the second signal receiving unit receives the signal; and an action detecting unit configured to detect an action of each finger attached with the acceleration sensor based on acceleration information outputted from each of the acceleration sensors.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view showing the configuration of an information input apparatus according to an embodiment of the present invention;

FIG. 2 is a view showing the functional block of the information input apparatus according to the embodiment;

FIGS. 3A and 3B are views to explain the operation detected by the information input apparatus according to the embodiment;

FIG. 4 is a view to explain the method of detecting a fingertip position by a two-dimensional position detecting unit of the information input apparatus according to the embodiment;

FIG. 5 is a view to explain the method of detecting an operation by an operation detecting unit of the information input apparatus according to the embodiment;

FIG. 6 is a first view to explain the error reduction procedure by the two-dimensional position detecting unit of the information input apparatus according to the embodiment;

FIG. 7 is a second view to explain the error reduction procedure by the two-dimensional position detecting unit of the information input apparatus according to the embodiment;

FIG. 8 is a flowchart to explain the flow of fingertip position detection procedure taken by the two-dimensional position detecting unit of the information input apparatus according to the embodiment;

FIG. 9 is a flowchart to explain the flow of error reduction procedure taken by the two-dimensional position detecting unit of the information input apparatus according to the embodiment;

FIG. 10 is a flowchart to explain the flow of operation detection procedure taken by the operation detecting unit of the information input apparatus according to the embodiment; and

FIG. 11 is a view showing the configuration of an information input apparatus according to a modification example of the embodiment.

### DETAILED DESCRIPTION OF THE INVENTION

An embodiments of the present will be described below with reference to the accompanying drawings.

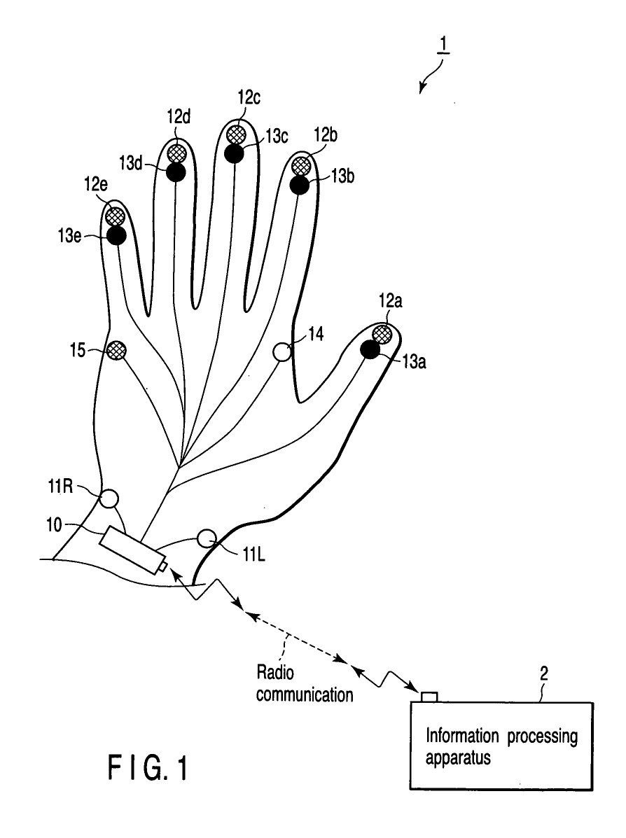

FIG. 1 is a view showing the configuration of an information input apparatus according to an embodiment of the present invention. An information input apparatus 1 of the present embodiment is connected with the main device, that is, an information processing apparatus 2 via radio communication (wireless) conformable to the Bluetooth (R) standard. As shown in FIG. 1, various components are attached to the fingertip, palm and wrist of a user operating the information processing apparatus 2. In FIG. 1, there is shown the appearance of the information input apparatus 1 when viewing it from the direction of the palm.

A signal processor 10 attached to the wrist controls the entirety of the information input apparatus 1. The signal processor 10 is connected with ultrasonic speakers 11R, 11L, ultrasonic microphones 12a to 12e, and acceleration sensors 13a to 13e. The signal processor 10 is further connected with a correction ultrasonic speaker 14 and correction ultrasonic speaker microphone 15. The ultrasonic speakers 11R and 11L are attached to both end portions of the wrist, respectively. The ultrasonic microphones 12a to 12e and acceleration sensors 13a to 13e are respectively attached to tip portions of five fingers. The correction ultrasonic speaker 14 and correction ultrasonic microphone 15 are respectively attached to both end portions of the palm. In the foregoing end portions of the palm, a change of the relative position from the wrist is small even if a hand action is made.

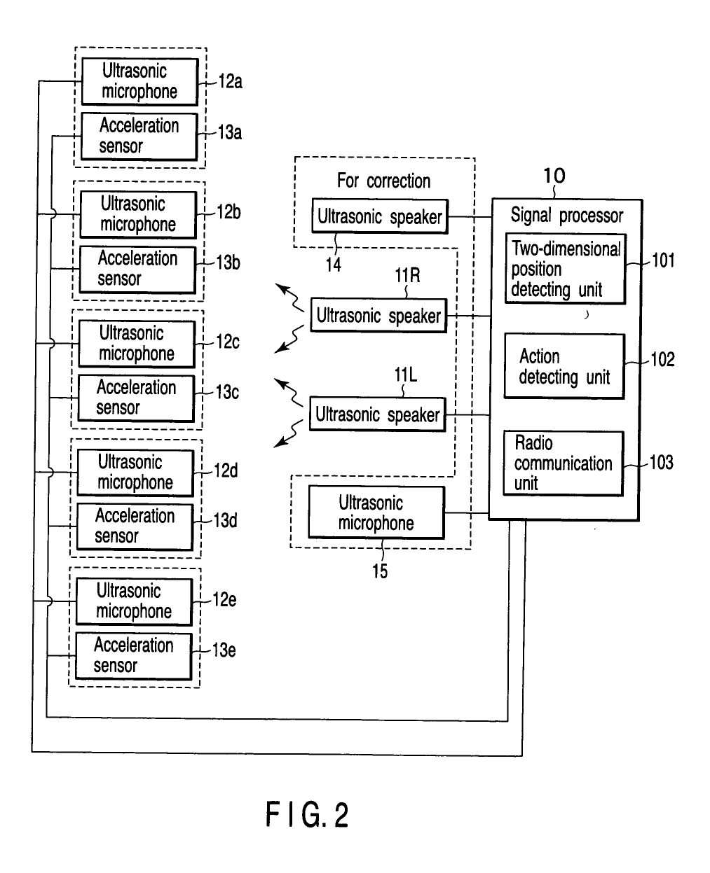

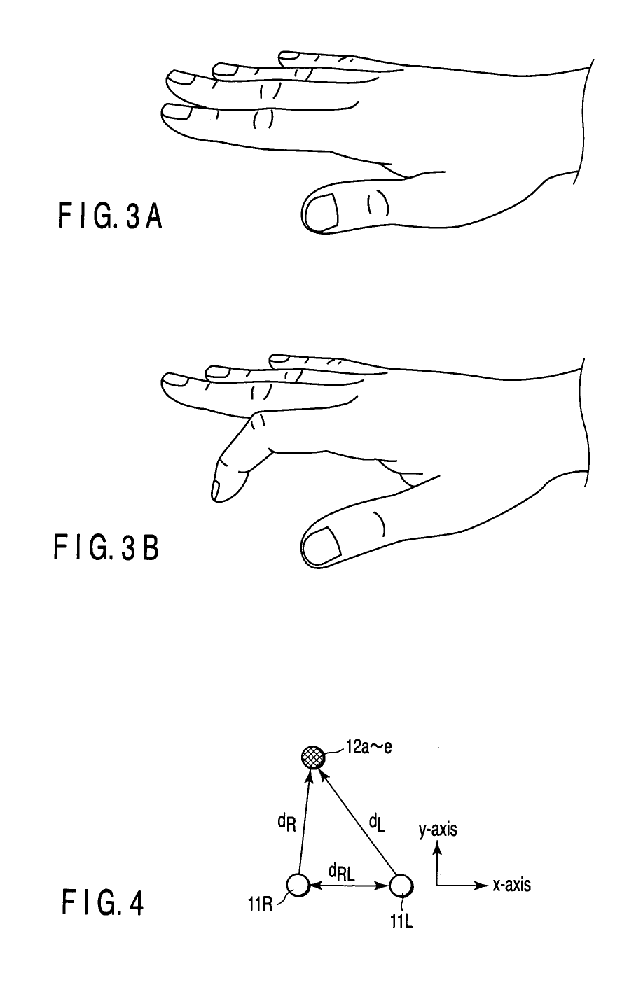

FIG. 2 is a view showing the functional block of the information input apparatus 1. As depicted in FIG. 2, the signal processor 10 controlling the entirety of the information input apparatus 1 has two-dimensional position detecting unit 101, operation detecting unit 102 and radio communication unit 103. The two-dimensional position detecting unit 101 detects the position of each fingertip attached with ultrasonic microphones 12a to 12e and acceleration sensors 13a to 13e. If an action like a hitting of a key by any finger is made, the action detecting unit 102 detects the action. The radio communication unit 103 sends the detection result of the unit 101 relevant to a finger making an action detected by the unit 102 to the information processing apparatus 2 via radio communication. For example, if a hand action is made from a state of FIG. 3A to a state of FIG. 3B, the information input apparatus 1 supplies positional information of the forefinger making the action to the information processing apparatus 2 as an input signal.

The method of detecting the fingertip position by the two-dimensional position detecting unit 101 will be described below with reference to FIG. 2 and FIG. 4.

The unit 101 generates an ultrasonic wave from ultrasonic speakers 11R and 11L attached to both end portions of the wrist so that ultrasonic microphones 12a to 12e attached to fingertips detect it. Then, the unit 101 detects a relative position of each fingertip from the wrist based on the principle given below.

First, the unit 101 calculates distances DR and DL of FIG. 4 from propagation time period from the time when ultrasonic speakers 11R and 11L generate ultrasonic wave to the time when ultrasonic microphones 12a to 12e detect it and speed of sound in air. In this case, a distance d_{RL} between ultrasonic speakers 11R and 11L is preset. By doing so, a position (x, y) of the ultrasonic microphones 12a to 12e using the position of the ultrasonic speaker 11R as the origin is obtained by solving the following simultaneous equations (1) and (2).
x²+y²=d_{R}² (1)
(x−d_{RL})²+y²=D_{L}² (2)

Thus, using the foregoing equations (1) and (2), the unit 101 detects the position (x, y) of the ultrasonic microphones 12a to 12e, that is, the relative position of each fingertip from the wrist.

Incidentally, the ultrasonic speakers 11R and 11L generate ultrasonic waves having a frequency different from each other, thus, the ultrasonic microphones 12a to 12e or the two-dimensional position detecting unit 101 may make frequency analysis to determine a signal sending source. The ultrasonic speakers 11R and 11L may generate the ultrasonic wave at regular intervals so that the ultrasonic microphones 12a to 12e or the unit 101 determines the signal sending source.

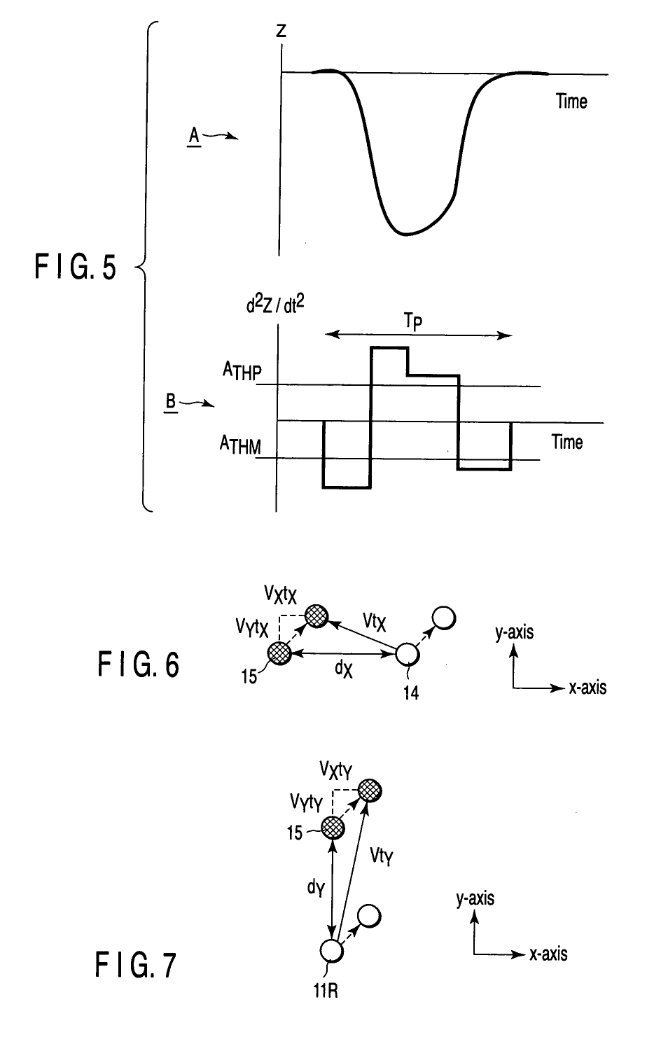

The method of detecting an action by the action detecting unit 102 will be described below with reference to FIG. 2 and FIG. 5.

The unit 102 detects a predetermined series of changes occurring in acceleration outputted by accel-eration sensors 13a to 13e attached to fingertips, thereby recognizing an action of just like hitting a keyboard. In this case, the acceleration sensors 13a to 13e have sensitivity in the direction vertical to the palm of the hand (x-y plane). The finger position when hitting action by finger produces changes as shown in FIG. 5A. In this case, the acceleration sensor detects acceleration as shown in FIG. 5B. The action detecting unit 102 recognizes that an action is made if the following predetermined changes (1) to (3), and the period Tp when the changes occur is shorter than a predetermined time.

(1) Acceleration is less than negative threshold value ATHM (2) Acceleration is more than positive threshold value ATHP (3) Acceleration is less than negative threshold value ATHM Incidentally, a bend angle of a joint may be detected using a bend sensor in order to improve accuracy.

As described above, the two-dimensional position detecting unit 101 detects the fingertip position while the action detecting unit 102 detects the action. Further, the information input apparatus 1 of the embodiment performs an error reduction procedure using the foregoing correction ultrasonic speaker 14 and correction ultrasonic microphone 15.

The unit 101 corrects a position detection error by a two-dimensional change in speed of sound resulting from the hand action, wind, etc. using the foregoing speaker 14 and microphone 15. The distance between the ultrasonic speaker 11R and the microphone 15 and the distance between the microphone 15 and the speaker 14 are approximately constant even if a hand action is made. In addition, the foregoing speaker 11R, microphone 15 and speaker 14 make a right angle. The unit 101 makes an inverse operation with respect to a two-dimensional change in speed of sound resulting from the hand action, wind, etc., and then, corrects it to achieve a reduction in fingertip position detection error. In this case, the foregoing inverse operation and correction are carried out based on two distances predetermined above and ultrasonic wave propagation time from speakers 14 and 11R to the microphone 15.

For example, the whole hand has a velocity (vx, vy) to air resulting from the hand action, wind, etc. As depicted in FIG. 6, the correction ultrasonic microphone 15 detects an ultrasonic wave generated from the speaker 14 at a speed of sound V after time tX. In this case, the following equation (3) is established using already-existing distance dX between the speaker 14 and the microphone 15, unknown vx, and vy.
(dₓ−vₓ tₓ)²+(v_{y} tₓ)²=(Vtₓ)² (3)

On the other hand, as shown in FIG. 7, the correction ultrasonic microphone 15 detects an ultrasonic wave generated from the speaker 11R at a speed of sound V after time ty. In this case, the following equation (4) is established using already-existing distance d_{y} between the microphone 15 and the speaker 11R, unknown vₓ, and v_{y}.
(vₓ tₓ)²+(d_{y}+v_{y} tₓ)²=(Vt_{y})² (4)

The two-dimensional position detecting unit 101 solves the simultaneous equations (3) and (4) to calculate vₓ and v_{y}. Then, the unit 101 applies correction based on the calculated vₓ and v_{y} to the fingertip position detecting method described referring to FIG. 4, thereby achieving a reduction in error of the speed of sound.

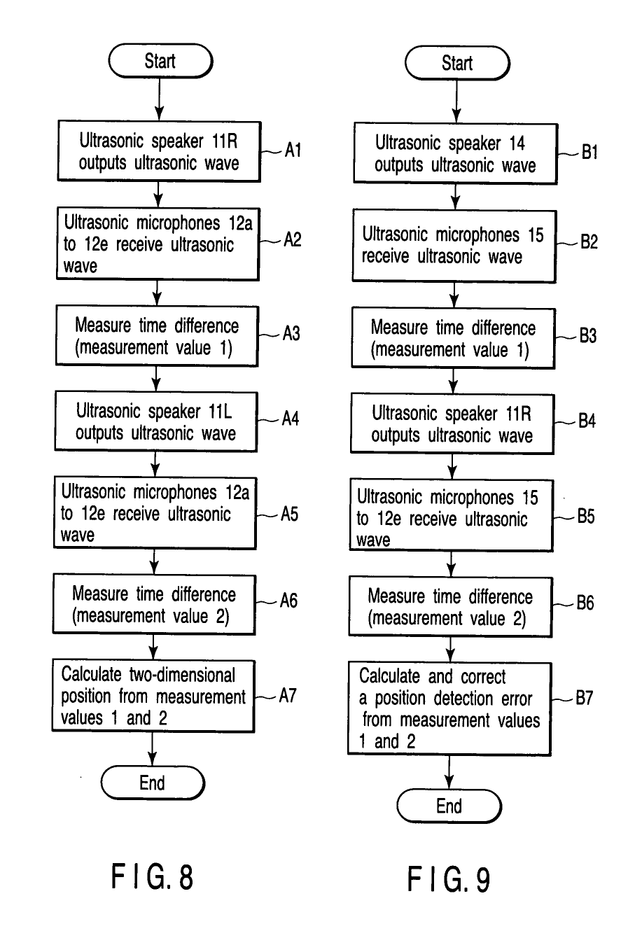

The operation procedures of the foregoing units 101 and 102 included in the information input apparatus 1 will be described below with reference to FIG. 8 to FIG. 10.

FIG. 8 is a flowchart to explain the flow of procedures performed by the two-dimensional position detecting unit 101.

The unit 101 performs the procedure so that the ultrasonic speaker 11R outputs an ultrasonic wave (step A1), and the ultrasonic microphones 12a to 12e detect the ultrasonic wave (step A2). The unit 101 measures the time difference (lag) from the output to detection of the ultrasonic wave (step A3).

Then, unit 101 performs the procedure so that the ultrasonic speaker 11L outputs an ultrasonic wave (step A4), and the ultrasonic microphones 12a to 12e detect the ultrasonic wave (step A5). The unit 101 measures the time difference from the output to detection of the ultrasonic wave (step A6).

The unit 101 calculates each position of the ultrasonic microphones 12a to 12e, that is, the two-dimensional position of each fingertip from two time differences calculated above (step A7).

FIG. 9 is a flowchart to explain the flow of the procedure for reducing an error caused by the two-dimensional position detecting unit 101.

The unit 101 performs the procedure so that the correction ultrasonic speaker 14 outputs an ultrasonic wave (step B1), and the correction ultrasonic microphone 15 detects the ultrasonic wave (step B2). The unit 101 measures the time difference (lag) from the output to detection of the ultrasonic wave (step B3).

Then, unit 101 performs the procedure so that the ultrasonic speaker 11R outputs an ultrasonic wave (step B4), and the correction ultrasonic microphone 15 detects the ultrasonic wave (step B5). The unit 101 measures the time difference from the output to detection of the ultrasonic wave (step B6).

The unit 101 calculates a position detection error by a two-dimensional change in speed of sound resulting from the hand action, wind, etc. from two time differences calculated above, and thereafter, corrects it (step B7).

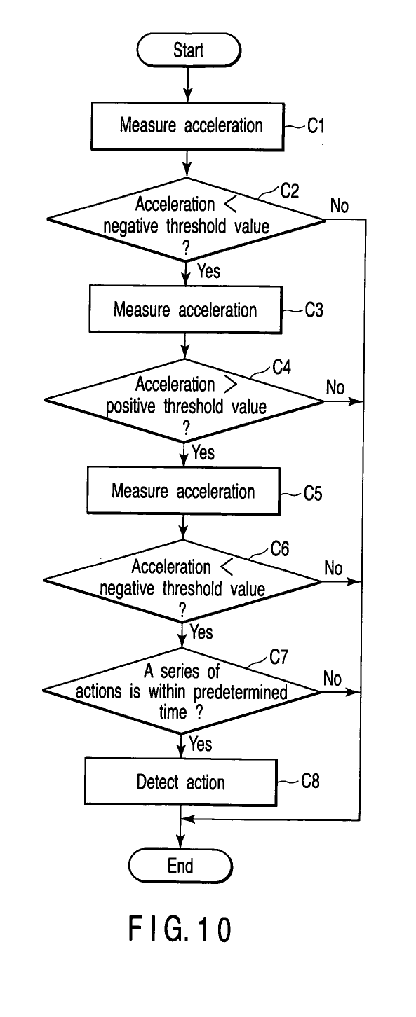

FIG. 10 is a flowchart to explain the flow of the operation detection procedure taken by the operation detecting unit 102.

The action detecting unit 102 determines whether or not the acceleration value outputted from the acceleration sensors 13a to 13e is less than a negative threshold value (step C1, step C2). If the outputted acceleration value is less than the negative threshold value (YES in step C2), the unit 102 determines whether or not the outputted acceleration value is more than a positive threshold value (step C3, step C4).

If the acceleration value is more than a positive threshold value (YES in step C4), the unit 102 again determines whether or not the outputted acceleration value is less than the negative threshold value (step C5, step C6). If the acceleration value is again less than the negative threshold value (YES in step C6), the unit 102 determines whether or not a series of changes confirmed according to the checks from step C1 to step C6 occurs within a predetermined time (step C7). If the change occurs within the predetermined time (YES in step C7), the unit 102 detects an operation by a finger attached with the acceleration sensor (step C8).

The information input apparatus 1 of the embodi-ment having the configuration described above uses ultrasonic speakers, ultrasonic microphones and acceleration sensors. Therefore, the information input apparatus 1 has low power consumption and is excellent in portability. In addition, each fingertip portion of each of the five fingers is attached with the foregoing ultrasonic microphone and acceleration sensor, and the fingertip position and action of the freely acting finger are detected. Therefore, information input speed is improved as well as keyboard input, and input contents becomes difficult to be guessed at by other persons. Moreover, it is possible to correct an error caused by a change in speed of sound resulting from hand action, wind, etc.

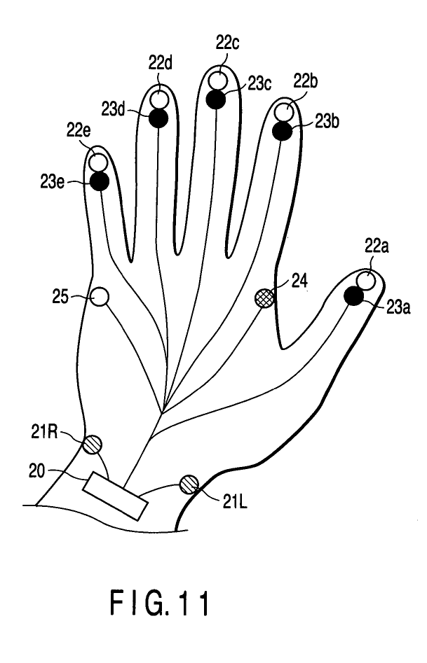

In the foregoing embodiment, ultrasonic speakers 11R and 11L are attached to both ends of the wrist while ultrasonic microphones 12a to 12e are attached to fingertips. Alternatively, for example, as shown in FIG. 11, ultrasonic microphones 21R and 21L may be attached to both ends of the wrist while ultrasonic speakers 22a to 22e are attached to fingertips. Even if positional replacement is made in ultrasonic speakers and microphones, the foregoing two-dimensional position detecting unit 101 and action detecting unit 102 can detect the action. For example, there is a case where the cost spent for the speakers is less than that spent for the microphones. In this case, the configuration shown in FIG. 11 is employed, and thereby, the information input apparatus is realized at a low cost.

In the foregoing embodiment, the ultrasonic microphone and acceleration sensor are attached to all five fingers. Alternatively, they may be attached to a predetermined finger only. The number of attached ultrasonic microphones and acceleration sensors may be mutually different. The present invention is not limited to key input, and is applicable to the operation of various electronic appliances.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An information input apparatus comprising:
first and second signal sending units attached to right and left end portions of a wrist with a distance therebetween;
at least one signal receiving unit, attached to a tip portion of each finger of a hand, configured to receive a signal outputted from the first or second signal sending unit;
an acceleration sensors attached to at least one fingertips of fingers attached with the signal receiving unit;
a fingertip position detecting unit configured to detect a relative position of a tip portion of each finger attached with the signal receiving unit in a two-dimensional space with its origin at the attached position of either the first or second signal sending unit based on an elapsed time period from a time when the first signal sending unit outputs a signal to a time when each signal receiving unit receives the signal, and an elapsed time period from a time when the second signal sending unit outputs a signal to a time when each signal receiving unit receives the signal; and
an action detecting unit configured to detect an action of each finger attached with the acceleration sensor based on acceleration information outputted from each of the acceleration sensors.

2. The apparatus according to claim 1, wherein the action detecting unit determines that a finger attached with the acceleration makes an action when a predetermined series of changes occurs in acceleration information outputted from the acceleration sensors within a predetermined period.

3. The apparatus according to claim 1, further comprising:
a correction signal sending unit attached to a first position on a palm of a hand;
a correction signal receiving unit attached to a second position on the palm of the hand in which a distance from the position of either the first or second signal sending unit used as the origin of the two-dimensional space and a distance from the position of the correction signal sending unit is approximately the same, and a segment connecting the position of either the first or second signal sending unit used as the origin of the two-dimensional space and a segment connecting the position of the correction signal sending unit makes an approximately right angle; and
an error correcting unit configured to calculate and correct an error of a fingertip relative position of each finger detected by the fingertip position detecting unit based on an elapsed time period from a time when either the first or second signal sending units used as the origin of the two-dimensional space sends a signal to a time when the correction signal receiving unit receives the signal, and an elapsed time period from a time when the correction signal sending unit sends a signal to a time when the correction signal receiving unit receives the signal.

4. The apparatus according to claim 1, wherein the first and second signal sending units output an ultrasonic wave having a mutually different frequency, and the signal receiving unit or the fingertip position detecting unit makes frequency analysis with respect to the received ultrasonic wave to determine the signal sending source.

5. The apparatus according to claim 1, wherein the first and second signal sending units output an ultrasonic wave having the same frequency with time difference therebetween.

6. An information input apparatus comprising:
at least one signal sending unit attached to a tip portion of each finger of a hand;
first and second signal receiving units, attached to right and left end portions of a wrist with a distance therebetween, configured to receive a signal outputted from the signal sending unit;
an acceleration sensors attached to at least one fingertips of fingers attached with the signal sending unit;
a fingertip position detecting unit configured to detect a relative position of a tip portion of each finger attached with the signal sending unit in a two-dimensional space with its origin at the attached position of either the first or second signal receiving unit based on an elapsed time period from a time when each signal sending unit outputs a signal to a time when the first signal receiving unit receives the signal, and an elapsed time period from a time when each signal sending unit outputs a signal to a time when the second signal receiving unit receives the signal; and
an action detecting unit configured to detect an action of each finger attached with the acceleration sensor based on acceleration information outputted from each of the acceleration sensors.

7. The apparatus according to claim 6, wherein the action detecting unit determines that a finger attached with the acceleration makes an action when a predetermined series of changes occurs in acceleration information outputted from the acceleration sensors within a predetermined period.

8. The apparatus according to claim 6, further comprising:
a correction signal receiving unit attached to a first position on a palm of a hand;
a correction signal sending unit attached to a second position on the palm of the hand in which a distance from the position of either the first or second signal receiving unit used as the origin of the two-dimensional space and a distance from the position of the correction signal receiving unit is approximately the same, and a segment connecting the position of either the first or second signal receiving unit used as the origin of the two-dimensional space and a segment connecting the position of the correction signal receiving unit makes an approximately right angle; and
an error correcting unit configured to calculate and correcting an error of a fingertip relative position of each finger detected by the fingertip position detecting unit based on an elapsed time period from a time when the correction signal sending unit sends a signal to a time when either the first or second signal receiving units used as the origin of the two-dimensional space receives the signal, and an elapsed time period from a time when the correction signal sending unit sends a signal to a time when the correction signal receiving unit receives the signal.

9. The apparatus according to claim 6, wherein the signal sending unit output an ultrasonic wave having a mutually different frequency, and the first and second signal receiving units or the fingertip position detecting unit makes frequency analysis with respect to the received ultrasonic wave to determine the signal sending source.

10. The apparatus according to claim 6, wherein each signal sending unit outputs an ultrasonic wave having the same frequency with time difference therebetween.

11. An information input method for an information input apparatus including: first and second signal sending units attached to right and left end portions of a wrist with a distance therebetween; at least one signal receiving unit, attached to a tip portion of each finger of a hand, configured to receive a signal outputted from the first or second signal sending unit; and acceleration sensors attached to at least one fingertip of fingers attached with the signal receiving unit, the method comprising:
detecting a relative position of a tip portion of each finger attached with the signal receiving unit in a two-dimensional space with its origin at the attached position of either the first or second signal sending unit based on an elapsed time period from a time when the first signal sending unit outputs a signal to a time when each signal receiving unit receives the signal, and an elapsed time period from a time when the second signal sending unit outputs a signal to a time when each signal receiving unit receives the signal; and
detecting an action of each finger attached with the acceleration sensor based on acceleration information outputted from each of the acceleration sensors.

12. An information input method for an information input apparatus including: at least one signal sending unit attached to a tip portion of each finger of a hand; first and second signal receiving units, attached to right and left end portions of a wrist with a distance therebetween, configured to receive a signal outputted from the signal sending unit; and acceleration sensors attached to at least one fingertips of fingers attached with the signal sending unit, the method comprising:
detecting a relative position of a tip portion of each finger attached with the signal sending unit in a two-dimensional space with its origin at the attached position of either the first or second signal receiving unit based on an elapsed time period from a time when each signal sending unit outputs a signal to a time when the first signal receiving unit receives the signal, and an elapsed time period from a time when each signal sending unit outputs a signal to a time when the second signal receiving unit receives the signal; and
detecting an action of each finger attached with the acceleration sensor based on acceleration information outputted from each of the acceleration sensors.
